(19) United States
(12) Patent Application Publication
(10) Pub. No.: US 2025/0232315 A1
(43) Pub. Date: Jul. 17, 2025

(54) ANALYSING COMMUNICATIONS DATA

(71) Applicant: Connected Impact Limited, London (GB)

(72) Inventors: Louise Nicolson, East Molesey (GB); Lucy Walton, Stockport (GB)

(21) Appl. No.: 18/848,639

(22) PCT Filed: Mar. 21, 2023
(86) PCT No.: PCT/EP2023/057244

§ 371 Date: Sep. 19, 2024

(30) Foreign Application Priority Data
Mar. 23, 2022 (GB) 2204061.2

(51) Int. Cl. G06Q 30/018; G06F 40/30

(52) U.S. Cl. CPC G06Q 30/018; G06F 40/30

(57) ABSTRACT

The present disclosure relates to systems and methods for generating environmental action triggers by monitoring raw environmental data of an organisation. A data capture tool captures raw environmental data and a set of comparison data. The captured raw environmental data and the set of comparison data is stored in a data structure, and a data analysis module compares the raw environmental data against the set of comparison data. A reporting module outputs an environmental action trigger based on the comparison, and routes a communication, including the action trigger, to one or more computer device.

### FIELD

The present disclosure relates to a computer system and method for analysing communications data, particularly but not exclusively data relating to the state of the environment.

### BACKGROUND

In recent years, the performance of organisations is increasingly connected to the perception of those organisations. Moreover, organisations are under increasing pressure to provide accurate reports pertaining to their non-financial performance, part of which is understood as Environment, Social and Governance (ESG) disclosure. This may be in the form of company shareholder reports, CSR (corporate social responsibility) reports, or any other kind of report. Organisations may be public companies, private companies, charities, schools or any other kind of structure.

There is particular emphasis nowadays on carrying out activities which improve the environment. So-called “greenwashing” is a phenomenon which has arisen where organisations purport to be “environmentally friendly”, while in practice not conforming to certain environmental requirements. Sometimes organisations report on environmental improvements by refashioning data from other areas, without changing their practices.

### SUMMARY

The present inventors have developed a computer system which is configured to receive raw environmental data, that is data representing the physical state of an environmental feature, such as CO2 emissions, and to utilise that raw data so as to enable environmental improvements to be achieved. The ‘raw’ data above may refer to environmental data that is extracted from reports by an organisation, which is then consolidated into a numerical form. It will be appreciated that the raw data may not represent directly monitored physical parameters, and may not be received in the raw format, but may be extracted from report data and consolidated into a raw, reported format.

Embodiments of the invention involve data analysis techniques in which baseline data (for example raw environmental data) is compared to a set of comparison data (for example reported data purporting to represent environmental factors). The nature of the data constituting the baseline and comparison data depends on the embodiment as discussed herein.

In one embodiment, the computer system is configured to generate alerts when it is detected that the raw environmental data represents an unsatisfactory state, and to route the alerts to a recipient (person or organisation) who is in a position to influence the environmental factor itself and/or the feature of the organisation. In such an embodiment, the raw environmental data may constitute the baseline data.

In another embodiment, the computer system is configured to generate a ‘transparency index’ which identifies and quantifies instances of “transparency” in an entity's reported environmental communications. Low transparency may manifest as a significant difference between an organisation's raw environmental data and a set of comparison data that may pertain to the same organisation, or to a known standard of environmental reporting. It may also manifest as a significant inconsistency between reported data from different sources or communications channels. In such embodiments, the baseline data may be constituted by the raw environmental data or reported environmental data, depending on what type of manifestation of low transparency is being considered.

A comparison of data according to the examples above may include identifying a relative lack of reporting on a particular environmental factor or theme in either the baseline data or comparison data, i.e., the organisation has failed to report on certain data points in one or more communication channel. Instances of low transparency may by described as having the ‘greenwashing’ effect mentioned above.

The inventors have recognised that there is a need to provide consistent and accurate data analysis in three distinct categories of an organisation's non-financial activity, including but not limited to ESG disclosures. By providing detailed data analysis in these three areas, it is possible to ascertain the proportion of reported activities carried out by an organisation in each heading, and therefore to feedback and improve on these activities. This is particularly important in the context of the environment. That is, by providing accurate analysis of an organisation's data concerning the environment, the proportion of focus which a company gives to the environment relative to social and governance matters can be ascertained, and, further, more detailed data analysis can particularly point out features of the environmental reporting and activities which may not comply with certain environmental frameworks. This can be done manually or in a semi-automated fashion by using keyword searches to find disclosures in documents.

The result of this is to enable an organisation to improve its “green” activities, and to overall provide an improved environmental impact.

One aspect of the disclosure provides a computer system for analysing data pertaining to an organisation, the system comprising:
a data capture tool configured to capture communication data from a plurality of communication channels pertaining to the organisation, the captured data comprising human readable text;
a data structure stored in computer memory configured to hold a count of each of a set of keywords or phrases which appear in the human readable text, the set of keywords and phrases comprising multiple groups, each group associated with a communication category; and
a reporting tool configured to generate an indication of a relative proportion of the communication data in each of the communication categories, based on the groups of keywords and phrases.

The system may comprise a data conversion tool which is configured to convert the captured data to a common format, to enable data extraction of data from the common format to be more easily accomplished.

The data capture tool may comprise an image capture device configured to capture an image of a communication generated on one or more of the communication channels. The image may be converted by the data conversion tool into a common format, for example a PDF format.

In some embodiments, data captured from the plurality of communication channels may be converted to a single PDF document for each respective communication channel. The communication channels may include employee communications (for example, electronic messaging such as emails or slack), organisational website communications, social media such as LinkedIn, Twitter, Profiles etc., investor communications, and public media such as newspaper articles.

The communication categories may comprise environment, social and governance, as indicators of non-financial information.

The data capture tool may comprise a user interface of a computer system. The user interface may have a display on which the captured data is displayed in a common format. A user may view the captured data and enter a count of each keyword or phrase which appears in the captured data. The count may be entered into a count recording application, such as a spreadsheet or other suitable data structure.

Alternatively, the data capture tool may automatically consume the communications data in the common format and carry out text recognition to identify keywords and phrases and generate an appropriate count of each keyword and phrase.

The keywords and phrases are collated into each group, each group associated with the communication category of that group.

In addition, companies may choose to benefit from a report of a reduced sample of their communications within a reduced time frame.

According to a second aspect of the invention there is provided a computer system for generating an environmental action trigger by monitoring raw environmental data of an organisation, the computer system comprising:
a data capture tool configured to capture raw environmental data from a first plurality of communication channels pertaining to an organisation, and to capture a set of comparison data from a second plurality of communication channels;
a data structure stored in computer memory and configured to store the captured raw environmental data and the set of comparison data;
a data analysis module configured to compare the captured raw environmental data against the set of comparison data; and
a reporting module configured to output, based on an analysis output of the data analysis module, an environmental action trigger, and to route an electronic communication comprising the environmental action trigger to one or more user interface of one or more respective computer device.

In some embodiments, the set of comparison data comprises a set of benchmark data,
wherein the analysis module is configured to determine, based on the benchmark data, a threshold standard of environmental practice, and
wherein the environmental action trigger comprises an alert, the alert indicating that the captured raw environmental data does not comply with the threshold standard of environmental practice.

In some embodiments, the set of comparison data comprises a set of external communication data issued by the organisation,
wherein the data analysis module is configured to determine, based on the external communication data, a reported standard of environmental practice by the organisation, and
wherein the output environmental action trigger is output based on a comparison of the reported standard of environmental practice and an actual standard of practice based on the raw environmental data.

In some embodiments, the electronic communication comprising the environmental action trigger further comprises a visual indication of a comparison index between the reported standard of environmental practice and the actual standard of practice based on the raw environmental data.

In some embodiments, the benchmark data comprises one or more of:
environmental regulatory data indicating a regulatory standard of environmental practice, and
competitor environmental data indicating an average reported standard of environmental practice of a plurality of competitor organisations.

In some embodiments, the external communications data comprises one or more of: social media publications, web pages, annual reports, sustainability reports, or ESG reports.

In some embodiments, the analysis module is configured to automatically classify features of the captured data by environmental semantic theme.

In some embodiments, the analysis module comprises a machine learning model, the machine learning model trained on a training data set in which environmental semantic themes are labelled in text of a plurality of training documents.

In some embodiments, the machine learning model is one of: a support vector machine, an XGBoost model, a long short-term memory model, and convolutional neural network.

In some embodiments, the system further comprises a data processing module configured to receive the captured data from the first plurality of communication channels in a first format and from the second plurality of communication channels in a second format and to process the captured data to convert the first and second format to a common format for storage in the database.

In some embodiments, the data structure is a relational database and each data entry in the relational database is stored in association with a unique identifier that specifies a respective source communication channel of the data entry.

In some embodiments, the one or more computer device, to which the electronic communication comprising the environmental action trigger is routed, comprises a computer device associated with the organisation.

In some embodiments, the one or more computer device, to which the electronic communication comprising the environmental action trigger is routed, comprises a computer device associated with a second organisation, the second organisation being an environmental regulatory organisation.

In some embodiments, the captured data from the first and second plurality of communication channels in the respective first and second formats is stored in the data structure in association with a timestamp that indicates a time at which the data is captured.

In some embodiments, the first and/or second format is in the group comprising: text data, HTML, PDF, image, JSON files, XML files, and data tables.

In some embodiments, the processing module is further configured to extract text content from the data captured from the first and second plurality of communication channels, and to define an entry in the relational database for each paragraph of text that is extracted.

In some embodiments, the processing module is further configured to store, in association with each data entry associated with a paragraph of text, an indication of an environmental theme to which the paragraph is semantically directed.

In some embodiments, the comparison of the captured raw environmental data against the set of comparison data comprises determining that a first environmental factor is addressed in only one of the first and second plurality of communication channels.

According to a third aspect of the invention there is provided a computer-implemented method for generating an environmental action trigger by monitoring raw environmental data of an organisation, the method comprising:
capturing, by a data capture tool, raw environmental data from a first plurality of communication channels pertaining to an organisation, and a set of comparison data from a second plurality of communication channels;
storing, in a data structure stored in a computer memory, the captured raw environmental data and the set of comparison data;
comparing, by a data analysis module, the captured raw environmental data against the set of comparison data; and
outputting, by a reporting module, based on an analysis output of the data analysis module, an environmental action trigger, and routing an electronic communication comprising the environmental action trigger to one or more user interface of one or more respective computer device.

According to a fourth aspect of the invention there is provided a transitory or non-transitory computer readable media on which are stored computer-readable instructions which, when executed by a processor of a computer device cause the processor to carry out a method according to the third aspect of the invention.

According to a fifth aspect of the invention there is provided a computer system for analysing data pertaining to an organisation, the system comprising:
a data capture tool configured to capture communication data from a plurality of communication channels pertaining to the organisation, the captured data comprising human readable text;
a data structure stored in computer memory configured to hold a count of each of a set of keywords or phrases which appear in the human readable text, the set of keywords and phrases comprising multiple groups, each group associated with a communication category; and
a reporting tool configured to generate an indication of a relative proportion of the communication data in each of the communication categories, based on the groups of keywords and phrases.

According to a sixth aspect of the invention there is provided a method of training a machine learning model to identify environmental themes in a document, the method comprising:
selecting a plurality of content sources, each content source comprising textual and/or image content that is primarily directed to a respective environmental theme, wherein at least one content source is selected for each of a plurality of predetermined environmental themes;
performing a text segmentation operation in which the content of each content source is separated into a plurality of semantically independent segments;
storing, in a relational data structure, each of the plurality of semantically independent segments in association with a correct identifier selected from a plurality of unique thematic identifiers, each of the unique thematic identifiers in the plurality thereof specifying a respective one of the plurality of predetermined environmental themes;
selecting a first portion of data in the relational data structure as training data, and a second portion of data in the relational data structure as validation data;
training a machine learning model to identify environmental themes expressed by text segments, based on the first portion of data;
applying the machine learning model to the second portion of data to determine, for each semantically independent segment represented by the second portion of data, a probability that the segment expresses each of the plurality of predetermined environmental themes and outputting, for each semantically independent segment, an indication of an environmental theme determined to have a highest probability of expression by the segment; and
determining that the machine learning model outputs for the semantically independent segments represented by the second portion of data exceed a minimum threshold of accuracy relative to the correct identifiers associated with each semantically independent segment represented in the second portion of data.

According to a seventh aspect of the invention there is provided a computer-implemented method of simultaneously capturing data from a plurality of data channels, the method comprising:
extracting, by a data extraction module, a plurality of raw data files from a respective plurality of data channels;
identifying and extracting, by the data extraction module in each raw data file, one or more of:
   a text data structure;
   an image data structure;
   a table data structure;
   a mathematical plot data structure; and
   a data structure in a JSON format;
at a data processing module executing one or more text identification program, converting data from each identified and extracted data structure into a output text data;
performing, by the data processing module, a text segmentation operation in which the output text data is separated into a plurality of semantically independent segments; and
storing the output text data in a database, wherein the database comprises a data entry for each of the plurality of semantically independent segments, and wherein each data entry comprises data of a common format.

According to an eighth aspect of the invention there is provided a method of training and applying a machine learning model to identify content in a data source that answers an input question, the method comprising:
generating a training data set comprising a plurality of candidate input questions, each candidate input question associated with a corresponding training content item and a Boolean indicator, the Boolean indicator indicating whether the training content item associated with each input question correctly answers the associated question;
based on the training data set, training a machine learning model to identify, for each candidate input question in the training data set, whether a content item correctly answers the input question;
providing to the trained machine learning model a first input question selected from the plurality of candidate input questions, and a source data structure comprising a plurality of candidate content items;
applying the machine learning model to each of the plurality of candidate content items to determine, for each candidate content item, a probability that the candidate content item correctly answers the input question; and
outputting one or more indication of one or more corresponding candidate content item that is determined to correctly answer the first input question.

### BRIEF DESCRIPTION OF THE DRAWINGS

For a better understanding of the present invention and to show how the same may be carried into effect, reference will now be made by way of example to the accompanying drawings in which:

FIG. 1A illustrates a schematic overview of the data analytics tool.

FIG. 1B illustrates the high-level architecture of the data analytics tool.

FIG. 2 illustrates a data extraction module which extracts data from multiple communications streams.

FIG. 3 illustrates an example of a user interface provided by the data analytics tool.

FIG. 4 shows an exemplary data structure which illustrates a code structure in an ESG database

FIG. 5 shows an exemplary data structure stored in a KPI database.

FIG. 6 shows a flow diagram representing an exemplary data extraction process.

FIG. 7 shows a flow diagram representing an exemplary method of extracting data from a social media website.

FIG. 8 shows a flow diagram representing an exemplary method of extracting text data from sources having different file types.

FIG. 8a shows an exemplary data extraction and alert routing flowchart.

FIG. 9 shows an exemplary relational database for storing text data in association with other related data objects.

FIG. 10 shows a flow diagram representing an exemplary method of constructing a training data set.

FIG. 11 shows a flow diagram representing an exemplary method of training and applying a machine learning model.

FIG. 12 shows an exemplary relational database for storing text data in association with a label.

FIG. 13 shows an exemplary repository data structure.

FIG. 14 shows an exemplary relation data structure for storing training data of a KPI analysis system.

FIG. 14a shows exemplary training data for a machine learning enabled KPI analysis system.

FIG. 15 shows a flow diagram representing an exemplary workflow for interacting with a user interface.

FIG. 16 shows an exemplary visual representation of the output of a KPI analysis method.

FIG. 17 shows an exemplary graph in which transparency analysis may be visually represented.

### DESCRIPTION OF THE EXEMPLARY EMBODIMENTS

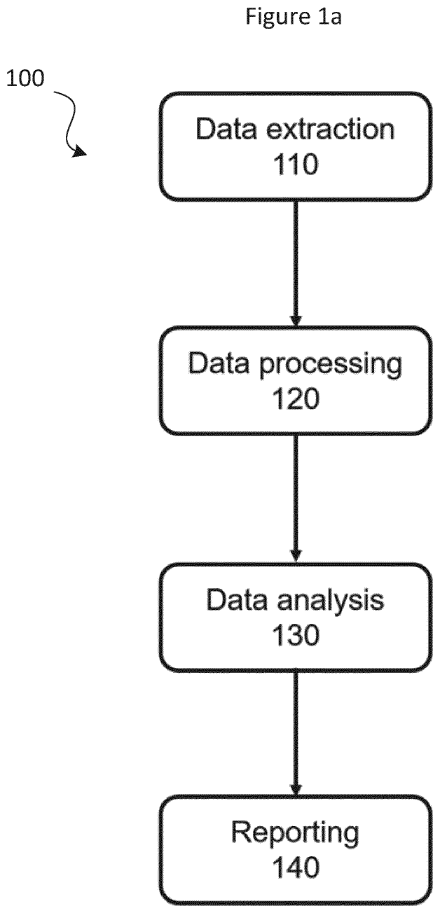

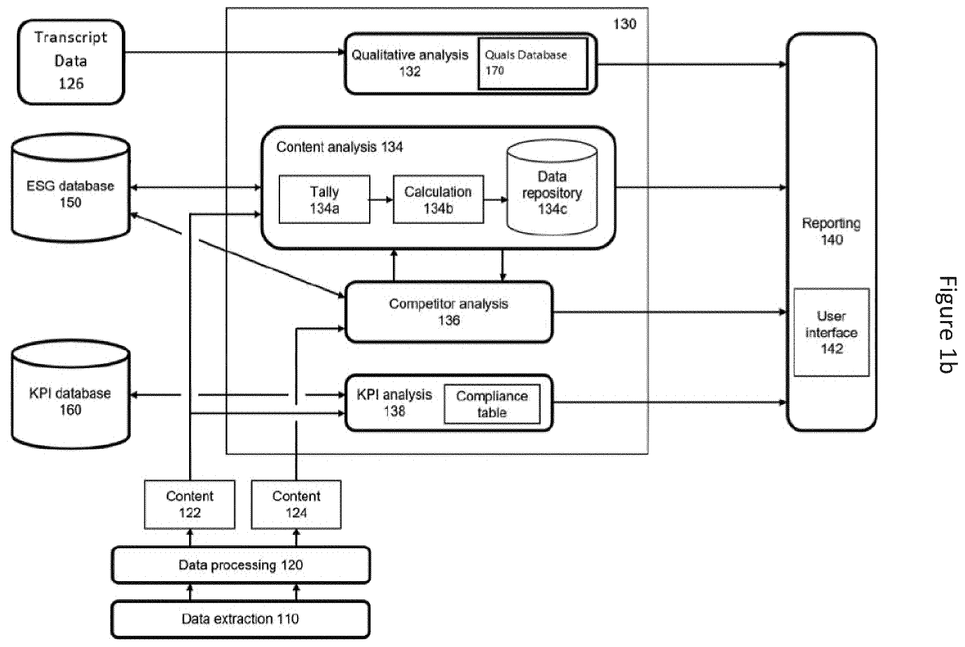

The data analytics tool described herein enables communications data to be tracked and analysed to generate data relating to the non-financial information present in an organisation's communication channels, where the organisation may for example be a public company, private company, charity, school or any other kind of structure. An overview schematic of the data analytics tool 100 is provided in FIG. 1A. A data extraction module 110 extracts data from communication channels. The data is collated and gathered for processing in a data processing module 120. Data analysis is undertaken in a data analysis module 130, and the results used to generate a report in a reporting module 140. A more detailed overview of the architecture used by the data analytics tool 100 is shown in FIG. 1B.

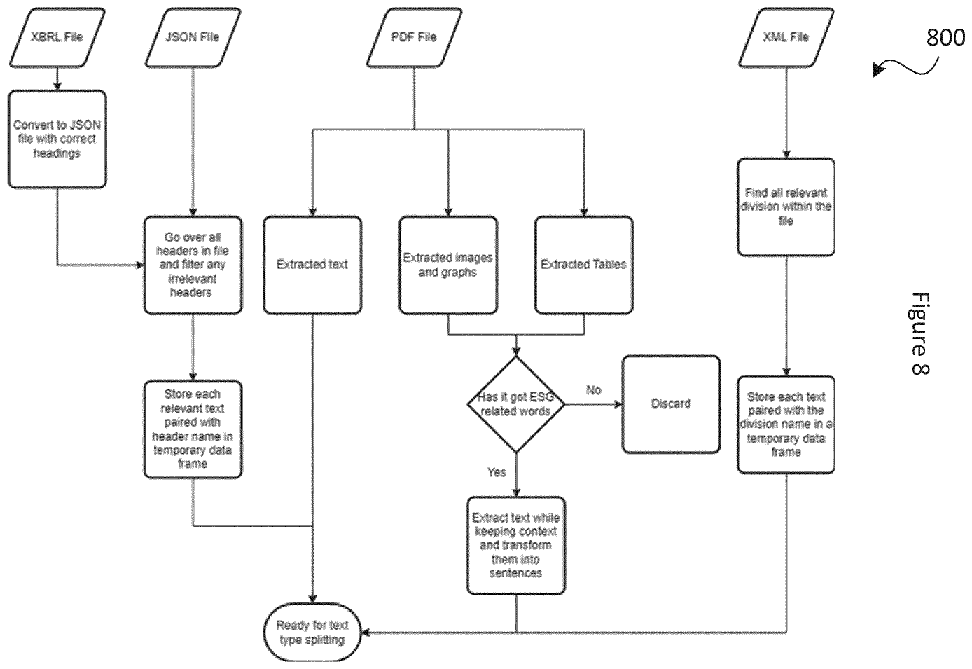

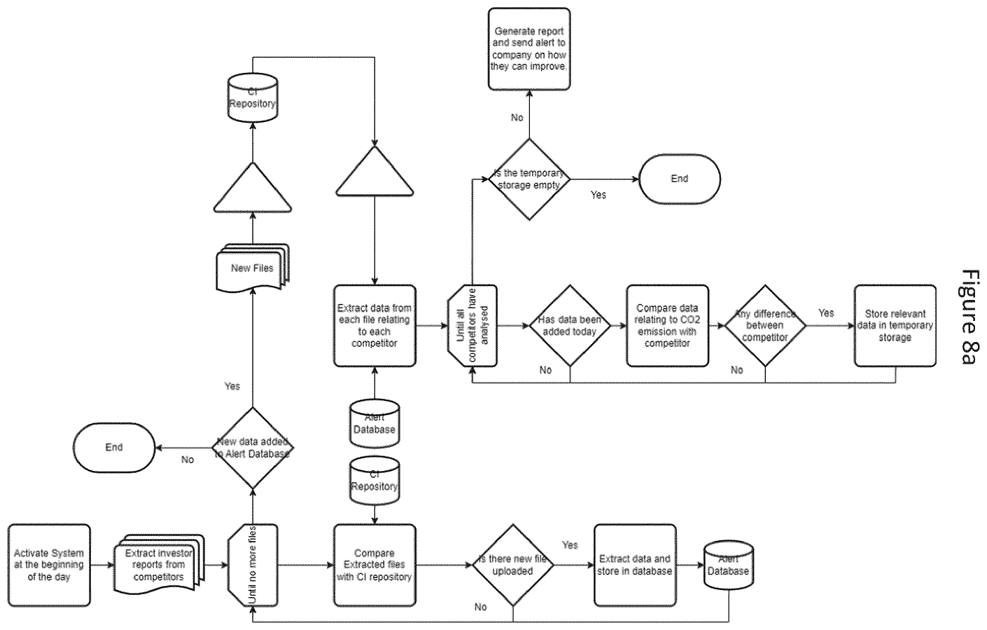

The generated data described above that relates to non-financial information present in an organisation's communication channels may take a plurality of forms. In some embodiments, the generated data may indicate an extent to which the organisation is transparent with respect to reporting on their non-financial activities, such as their environmental impact. The present description refers to a ‘transparency index’, which may quantify this extent of transparency. In other embodiments, the generated data may be configured to cause the tool to route an alert communication, which may indicate that the generated data (indicative of content in the communications data) is non-compliant with respect to one or more metric or benchmark. Reference is made to FIG. 8a, which illustrates an exemplary workflow in which an alert may be routed. Alternatively, or additionally, the routed alert communication may indicate that a lack of reporting exists in respect of a particular environmental data point, that there is a relative lack of disclosure in either the baseline or comparison data in respect of a particular environmental factor, or that there is a discrepancy or inconsistency exists between baseline and comparison data of the organisation which, as described later herein, may indicate an instance of the phenomenon of ‘greenwashing’.

### Data Analysis

In the present embodiment, four independent analyses are applied to an organisation's data. It will be appreciated however that any number of analyses may be carried out, depending on the application of the analysed data. The analysis may be performed by a data processing module 120, which is a suitably programmed computer, aided by a human user as described herein.

A qualitative analysis module 132 utilises framed interviews with members of the organisation, for example the leadership team, which are recorded and digitally transcribed. The qualitative data resulting from these interviews is then coded manually. That is, keywords and phrases in the transcripts may be grouped under ‘titles’ or ‘codes’. This process may be automated using machine learning if operating on large data sets.

More generally, the qualitative analysis module may operate on internal and/or external interview data, and or survey responses. The interviews may be internal interviews if the content of the interview brings confidentiality or privacy concerns. However, the qualitative analysis module may further operate on interviews that represent external perspectives, such as those of other stakeholders and investors. The survey responses may include free text responses to questions.

Note that an inductive coding method is applied, in that the codes assigned to the qualitative data (assigned to the keywords and phrases) are not predefined; they are created based on semantic extraction from the qualitative data. The assignment of codes may be based on manual analysis of the meaning of words and sentence structures in the data, or may be automatically conducted by a machine learning system operating a text classification model when large data samples are used. As many codes as possible are manually applied to the qualitative data and coded data is stored in a qualitative analysis database 170. One or more themes are then identified inductively by building associations and differentiators between the coded data. One or more themes are then assigned under a category code, wherein exemplary category codes may include: “Environmental”, “Social”, or “Governance”. Note that the themes are a higher order categorisation than the codes that are applied to the qualitative data; themes are exclusive to the category code to which they are assigned. A particular theme may be associated with one or more codes. It will be appreciated that the codes may themselves be keywords and phrases, but are not necessarily explicitly recited in the transcripts or free text survey responses.

Upon completion of the qualitative analysis, the qualitative analysis database 170 stores each category code, the themes assigned under each category code, and the codes associated with each theme.

Content analysis 134 is performed using codes stored in an ESG database 150. To perform content analysis, a standard set of predefined codes are extracted from the ESG database 150, which is an external local data repository (for example, a spreadsheet application such as Microsoft Excel). The ESG database 150 stores words and phrases relating to ESG criteria; for example, the ESG database 150 may store phrases such as “coal power”, “renewables” and “biodiversity” under a theme that is assigned under the category code “Environmental”.

In an embodiment discussed later, the quantitative analysis module 134 is partially or wholly automated by the application of natural language processing algorithms to apply the codes stored in the ESG database 150.

A content analysis module 134 searches separate content 122, for example a PDF text, for the predetermined key words and phrases stored in the ESG database 150. Generation of PDF content which may be subject to this searching is described later. The searches are fully automated. In a tally step 134a, each time a key word or phrase from the ESG database 150 is identified in the data, a tally is incremented. When the search has parsed the entirety of content 122, the total frequency count obtained by the tally is recorded in the ESG database. The key word or phrase, its accompanying ESG code tag, and the tally total are then manually outputted to a calculation step 134b within the content analysis module 124.

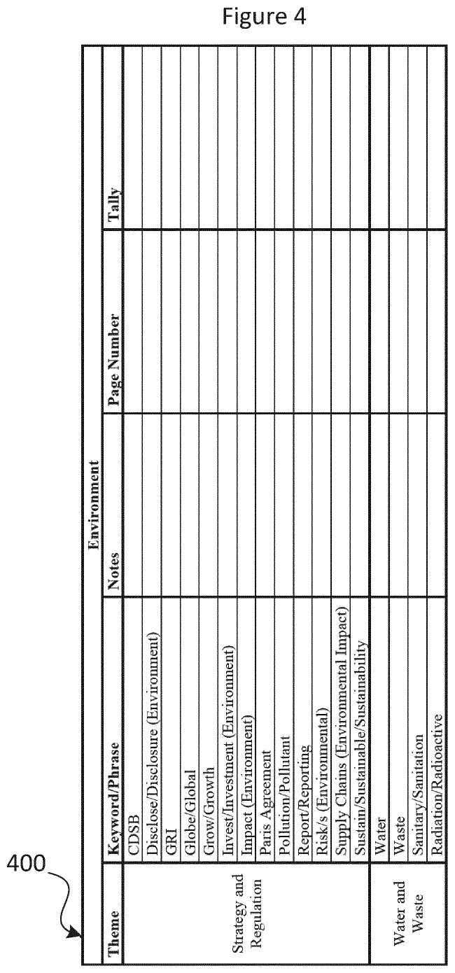

FIG. 4 shows an exemplary ESG data structure 400, comprising a plurality of keywords and phrases which represent codes. The ESG data structure 400 further shows two exemplary themes, each theme comprising a quantity of codes. As described previously herein, codes may be allocated to a particular theme based on semantic associations between the codes. Note that codes are not inductively derived in the content analysis. Themes into which codes are grouped may also be a predefined standard set. The exemplary ESG data structure 400 further includes columns and regions therein, in which data pertaining to notes, page numbers and count tallies from the content analysis may be input. It will be appreciated that the ESG data structure 400 is provided by way of example; further fields and columns may be implemented in other embodiments.

The calculation step 134b utilises quantitative analysis software, such as Microsoft Excel. In one embodiment, the tally totals for each ESG code are summed. The sum of frequencies of all ESG key words and phrases in the data can then be obtained by summing the three resulting sums, and subsequently used to determine the total proportion of key words and phrases associated with each of the environmental, social and governance codes. The results are stored in data repository 134c, which may for example be the same Excel spreadsheet as that utilised by the calculation step 134b.

In an embodiment described later, the content analysis module 134 is automated by the application of relevant software libraries from the python ecosystem, such as pandas or nltk.

A competitor analysis module 136 initially sends independent qualitative content 124, for example a PDF text, to content analysis module 134. Generation of PDF content which may be subject to this searching is described later. The content 124 is generated from data related to the communications of the organisation's closest competitors. The identification of a closest competitor may be made by using a hybrid approach that combines the opinion of the organisation with additional financial and non-financial data (for example provided by a third-party service such as FactSet) that is able to identify closest competitors.

A key performance indicator (KPI) analysis module 138 performs KPI analysis. KPI indicators are held in a KPI database 160, which is stored in an external local data repository (for example, in a spreadsheet application such as Microsoft Excel). The KPI indicators stored therein may comprise a combination of core metrics published by the World Economic Forum, and a selection of non-financial disclosure frameworks specific to the sphere of activity in which the organisation operates. Examples of such indicators are CO₂ emissions and compliance with Task Force on Climate-Related Financial Disclosures (TCFD) guidelines and UN Sustainable Development Goals. One example of a framework may be the SASB Materiality Map, though it will be appreciated that other non-financial disclosure frameworks may be used.

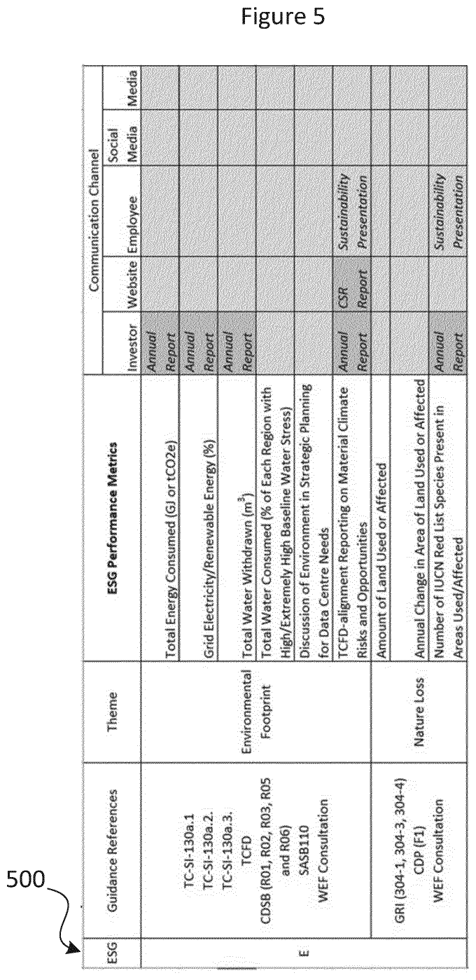

FIG. 5 shows an exemplary extract from a KPI data structure 500 stored in the KPI database 160. FIG. 5 shows a plurality of KPI indicators, listed in the example of FIG. 5 under the column heading ‘ESG Performance Metrics’. It will be appreciated that the terms ‘ESG performance metrics’ and ‘KPI indicators’ may be used interchangeably herein. FIG. 5 further shows two exemplary themes, where each theme is associated to a quantity of KPI indicators. Note that the exemplary themes shown in the KPI data structure 500 are assigned under the “Environmental” category code. FIG. 5 further illustrates an exemplary compliance table 138a, as described below.

The KPI analysis module 138 searches the content 122 for terms related to each of the KPI measures stored in the KPI database 160. From these searches a compliance table 138a is compiled, which lists each indicator stored in the KPI database 160 and allocates a visual indicator based on the quality of indicators identified in the search results. For example, a first type of visual indicator is applied if the given indicator, searched on content 122, is of a level considered acceptable internationally. A second type of visual indicator is applied if the given indicator appears in content 122, but is not of a level considered acceptable internationally. A third type of visual indicator is applied if the given indicator is not found in content 122. Exemplary visual indicators may include colour codes, wherein a different colour is assigned for each of the above categorisations of KPI indicator quality.

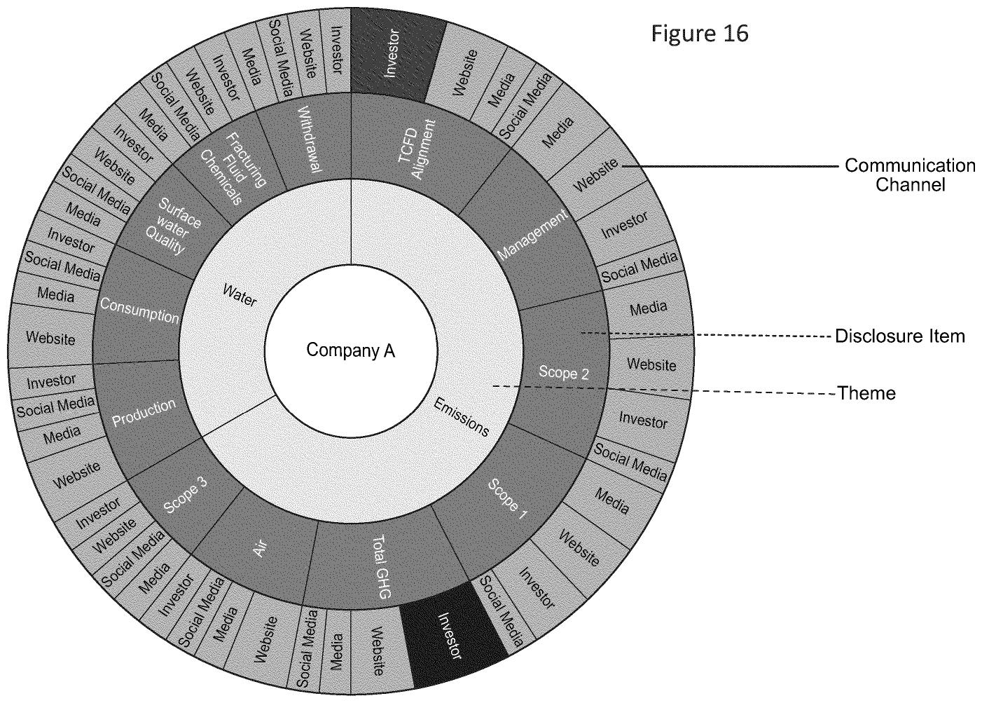

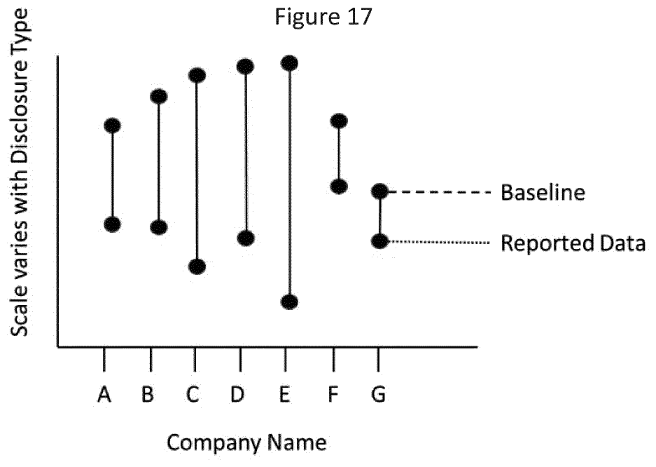

The KPI analysis may also be used to construct visualisations such as those shown in FIGS. 16 and 17. FIGS. 16 and 17 show visual representations of the analyses that are described herein. FIG. 16 shows a ‘sunburst chart’, which is means of visually representing a result of the KPI analysis. The chart comprises a plurality of bands in three layers, each band representing a different theme, code, or communication channel, depending on the layer. An angular size of each band may indicate a reporting frequency or reporting adequacy of the associated theme, code or channel.

FIG. 17 shows a “transparency index” graph which may be generated based on the data analysis techniques described herein. When used to compare environmental data, the graph may be generated to visualise an extent of greenwashing within a company, and a relative extent of greenwashing with respect to one or more other entity, e.g., companies A-G in FIG. 17.

In a possible embodiment, the compliance table 138a may alternatively use a numerical Likert scale, in place of the visual indicators disclosed above, to provide a more accurate index of the number of positive search results for a given indicator from the KPI database 160.

Returning to FIG. 5, note that an exemplary compliance table 138a, including visual indicators, is shown within the KPI data structure 500. For example, the first type of visual indicator described above is applied to the ‘CSR Report’ block. This implies that the quality of indicators in the content 122 relating to the performance metric “TCFD-Alignment Reporting on Material Climate Risks and Opportunities’ is of an acceptable level. Note that the communication channel from which the content is extracted is the ‘website’ channel.

### Channels for Data Extraction

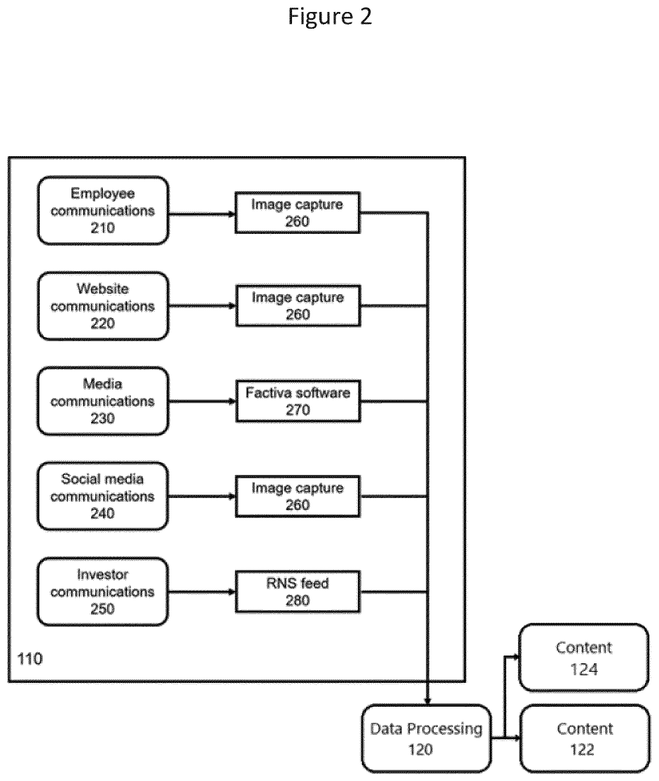

The content 122 and 124, respectively used in the content analysis module 134 and KPI analysis module 138, comprises data from multiple communication streams. As shown in FIG. 2, the data extraction module 110 extracts data from multiple communication streams: five streams are shown by way of example in FIG. 2. Various categories of communications are used as inputs. The following are given by way of example only. Employee communications 210 entails internal data such as intranet content, which may be captured over the course of a monitoring period: typically, a financial year. It will be appreciated that data of this kind may be further communicated to external parties, subject to privacy; investors or other stakeholders, for example. The data may be extracted capturing images of these communications using an image capture device 260, or by any other means. For example, social media communications such as a twitter feed, or webpages, could be extracted by image capture, and exported to a document in, for example, a PDF editing application.

Website communications 220 refers to communications through the official website of the organisation; an image of the website may be captured using an image capture device 260. In order to correlate the extracted data from the website with the other extracted data, the image capture could take place at a single moment in time, where possible, during the same monitoring period.

Data relating to media communications 230 may comprise articles published in the traditional and online press, such as newspapers and financial journals. In order to limit the amount of data to be extracted to a manageable amount, tools may be used to filter the media communications from which data is extracted for any particular analysis. Factiva provides a software tool 270 which uses key words and dates to extract media communications from the same annual period whose subject is, or relates to, the organisation. Another way of filtering may be to apply a numerical limit, for example limited to publications which publish more than two articles about the client over the monitoring period.

Social media communications 240 may consist primarily of ‘posts’ about the organisation on social media platforms such as LinkedIn, Twitter, Facebook etc. This data may be gathered over the same sample period, via an image capture device 260.

Investor communications 250 may comprise information related to the organisation held by the Regulatory News Service (RNS) feed of the London Stock Exchange. The relevant RNS feed 280 may be extracted using a feed service such as FactSet. Note that a filtering step may be applied, such that irrelevant information is not extracted.

Once data extraction is complete for a particular period, the data is processed by the data processing module 120. The data processing comprises combining the extracted data from the incoming communication streams inside the data extraction module 110 into a readable PDF format. For ease this can be a single PDF document for each communication channel 210-250, but it will be appreciated that multiple documents may be used. For the data stored as captured images, this requires the application of optical character recognition (OCR) software that renders the image as a readable PDF.

In other embodiments, as described later herein, content from communication channels may be captured directly and text content therein may be extracted and stored in a database in a structured format. Where image content is identified, or where content from a communication channel is gathered via an image capture device, the image content may be processed to identify text content therein, and any extracted text content may be stored in a database with other text content extracted from each communication channel.

Content 124 used in the competitor analysis module 136 may also be generated via the data extraction module 110. However, the communication streams are those for a competitor organisation, rather than the client organisation itself. For competitor communications only a restricted set of the available streams may be utilised, to simplify the analysis undertaken in the competitor analysis module 136. The communications streams, from which the data in content 124 are extracted, may be chosen based on or in view of input from the client organisation.

### Reporting

The results of each submodule of the data analysis module 130 are used by a reporting module 140 to construct a report for the organisation detailing the analysis of their non-financial and ESG communications. The report is generated as a set of visual indications on a display of a user interface 142. Results from each analysis submodule are displayed on the same user interface but reported separately, as the results from the analyses are independent.

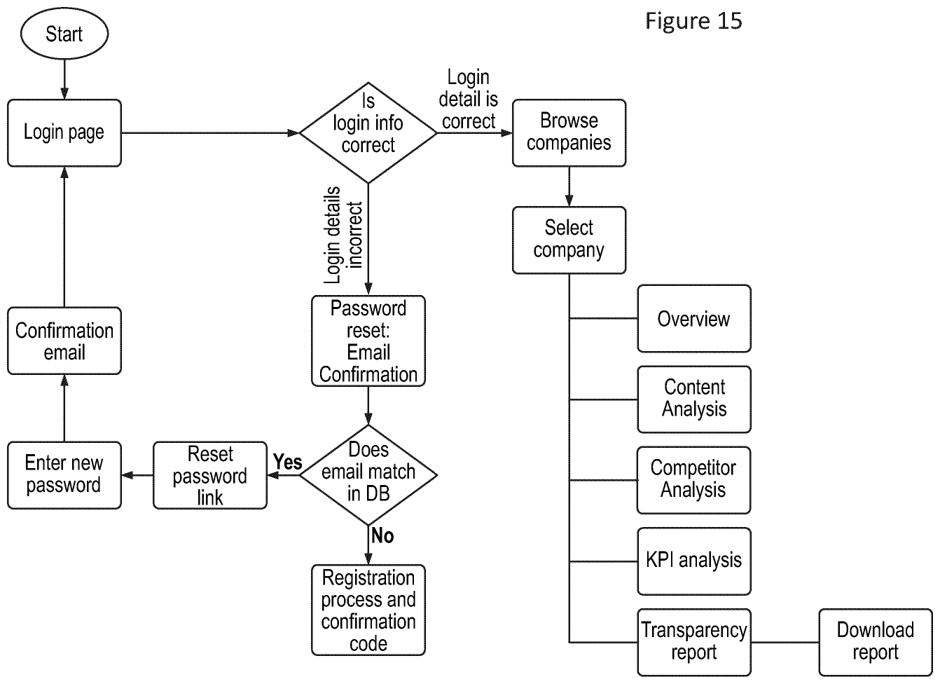

Reference is made to FIG. 15, which shows an exemplary flow chart that illustrates a process for operating a user interface, such as the interface 142 described above. The user interface may be more generally configured to enable navigation and querying of a CI database, e.g., the alert database. The flowchart of FIG. 15 comprises a left-hand branch that illustrates a security protocol for restricting access, and a right-hand brand illustrating how data pertaining to particular entities, e.g., reports constructed according to the various analyses described herein, may be accessed.

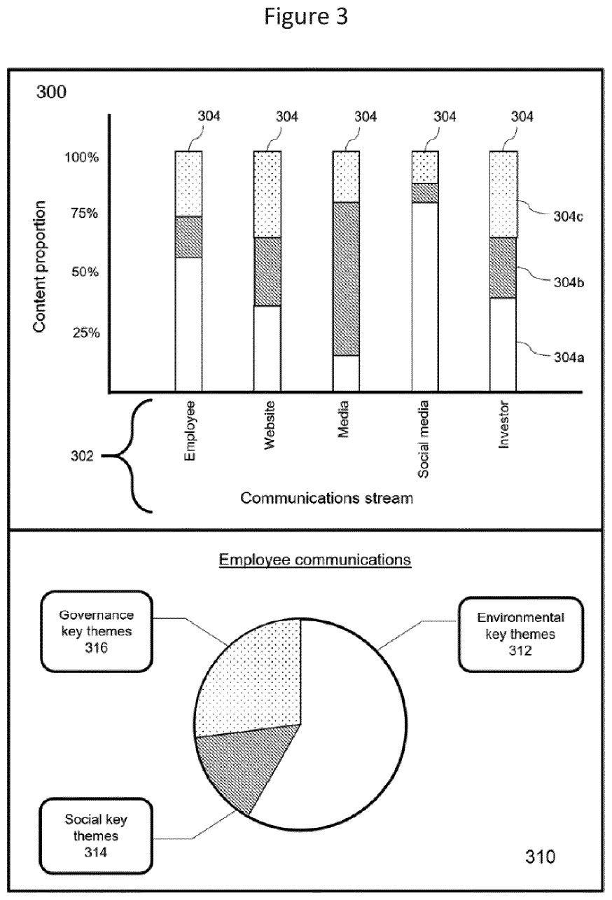

An illustration of the quantitative reporting displayed on the user interface 142 and based on the results of the content analysis module 134 is given in FIG. 3. The figure is based on hypothetical data and serves for illustrative purposes only. The example user interface 142 consists of a bar chart 300, and a chart 310. For simplicity only one pie chart 310 is provided in FIG. 3, but it should be appreciated that a pie chart 310 could be displayed for each individual communications stream. Each chart is built from the data repository 134c obtained during content analysis module 134. The bar chart 300 may display data for every data stream 302. Each communication stream labels a stacked bar 304 displaying the calculated proportion of environmental 304a (block fill), social 304b (diagonal pattern), and governance 304c (dotted pattern) key words and phrases.

For a given communications stream 302, an additional pie chart 310 may be reported. This chart displays the same data as the stacked bar 304 for that stream, but includes a breakdown of the environmental key themes 312, social key themes 314 and governance key themes 316 identified by the content analysis module 134. The additional charts for a given communications stream 302 may be provided upon request from the client organisation. The key themes identified during the qualitative analysis 132 block are not reported on a pie chart 310.

Additional reporting outputs that can be displayed by the user interface 142 consist of: the key themes identified from the qualitative analysis module 132; the qualitative results of the competitor analysis module 136, specifically including examples of good practice noted in the communications of the identified competitor; and the compliance table 138a obtained during the KPI analysis block 138. The description above outlines a transparency index. That is, an organisation's data may be analysed to determine a measure referred to herein as a ‘transparency metric’. This compares baseline data against comparison data to identify inconsistencies between raw data and reported data, or between reported data of different channels. The transparency metric may further identify insufficient reporting, such as a lack of coverage of a particular raw data point in reports from certain channels, or a lack of basis for statements of environmental commitments, as reported in internal documents, such as company reports etc.

By conducting the above process of identifying and quantifying differences (according to a transparency metric) between an organisation's environmental disclosure and the same organisation's non-financial communications, instances of greenwashing may be identified and quantified. Reference is made again to FIG. 17, which shows an exemplary graph that may be constructed to visually assist in identifying and quantifying an instance of greenwashing.

It is expected that the raw environmental data represents numerical data that is consolidated from environmental reports issued by the concerned entity or organisation. The raw environmental data may represent accurate measurements of physical environmental features, such as CO2 emissions, thermal efficiency, water consumption, water withdrawal, surface water quality, ground water quality, air emissions, hazardous waste, land usage, change in land use, power consumption, power consumption from renewable sources etc., derived from data generated by sensors deployed by the organization in its operating sites. The measure of agreement may be provided on a scale referred to herein as the ‘transparency index’, and may indicate an extent to which the organisation is transparent with respect to reporting on their non-financial activities. The measure of transparency of the organisation, according to the transparency index, may also be displayed on the user interface 142 with a visual indication. Reference is made to the exemplary reporting interface of FIG. 3, which may, though not shown, further include a representation of the transparency index, and the organisation's extent of transparency according to the transparency index.

A reporting module of the system described herein, such as the reporting module 140 of FIG. 1, may be further configured to communicate an alert in respect of the environmental communications of an entity. Reference is made again to FIG. 8a, which illustrates an exemplary workflow, according to which an alert may be generated. The alert may, based on analysis of extracted data and benchmarked against one or more environmental reporting metric, flag an instance of a monitored environmental parameter (e.g., carbon emissions) exceeding a predefined threshold, or may otherwise flag an instance of bad practice in respect of the environmental transparency of the entity through its environmental reporting. That is, the alert may be triggered based on a classification of the environmental practices of the entity, compared against average data or other comparison data. The alert may further prompt an action for improving the environmental practices and/or environmental impact of the entity, thereby forming part of a technical control loop for actioning processes that improve the environmental impact of the entity.

The extracted data referred to above may include raw data extracted from environmental communications, such as reporting on environmental data and processes of the entity concerned. Communications from which data is extracted may further encompass investor reporting, and may comprise data of a plurality of formats, such as PDF and HTML, for example. In embodiments where an organisation's environmental data (raw or reporting) is compared against other organisations', the comparison data may, depending on the embodiment correspond to a regulatory reporting metric, or a comparison metric established by extracting environmental associated with one or more competitor entity, or other entity operating in a comparable space or sector, and averaging over the data for each competitor entity. Methods for input of the comparison data to the system may correspond to the data extraction techniques described later herein. That is, the data extraction techniques may be applied to data sources from competitor entity communication channels, or communication channels related to the comparison metric and may be processed and stored in a database for access when conducting the above analysis.

For implementing the transparency index, the comparison data may be extracted from environmental data as reported in environmental communication channels by the organization. In some embodiments, the comparison data against which baseline data is compared for the purposes of applying the transparency index may be constituted by data that is externally reported by one or more competitor, or other comparable entity.

In some examples, the alert may be routed to a client device associated with the entity. The alert may identify the poor aspect of environmental reporting and prompt or trigger the entity to implement processes for improving such practices.

In other embodiments, an alert generated in respect of a first entity may be routed to one or more of a first client device associated with the first entity, and a second client device associated with a second entity. The second entity may be, for example, an independent regulator or pressure group that reports on sustainability factors or other environmental factors relating to the first entity. Other parties may also constitute the second entity, and any number of entities may be alerted in embodiments.

In instances where the alert generated in respect of a first entity is not routed to a client device of the first entity, it will be appreciated that the alert nonetheless represents a vehicle for improvement of environmental practices and reports, because investor or regulator pressure and reporting may prompt the same technical implementation of processes for improving the first entity's environmental impact reports.

With reference to the data analysis module described herein, the data analysis module may, in some embodiments, be configured to perform artificial intelligence or machine learning techniques to identify and classify salient features of the extracted data. A machine learning-enabled data analysis module may comprise a machine learning model, which may operate on an input data packet reflective of data extracted by the data extraction module. Technical configuration and operation of such a machine learning model is described in more detail later herein.

A machine learning-enabled data analysis module may be applied to automate and improve the accuracy of the classification analysis that triggers the alerts, thereby forming part of the above- described control loop.

Furthermore, the classification method conducted by the analysis module may—in embodiments where the analysis module conducts the analysis at least in part using a machine learning model—be configured to perform the classification method by training the machine learning model using a training data set.

The present disclosure is, at least in part, directed to routing communications such as alerts based on the environmental reporting practices of an entity, the alerts identifying and prompting processes for resolving such practices. The phenomenon known as ‘greenwashing’, outlined in the background section herein, may manifest as inconsistency between raw data—which reflects functional environmental data generated, for example, according to a standard methodology or by an independent auditing entity—reported in internal company organisations, and environment-focused content in other channels of communication, such as social media posts, online articles, and other publications that interpret or otherwise refer to the environmental data. In some examples, greenwashing may manifest as an exaggerated or misleading interpretation of the environmental data, or as a lack of reference to salient pieces of the environmental data.

As described above, the KPI analysis module 138 searches the content 122 for terms related to each of the KPI measures stored in the KPI database 160. From these searches a compliance table 138a is compiled to assess the extracted content against the KPI indicators. The raw data above may correspond to the same content 122 described with reference to FIG. 1. That is, the same extracted data which is assessed against the KPI indicators may also be assessed against external communications associated with the same entity to identify instances of greenwashing that manifest as inconsistency between data from internal and external communication channels of that entity.

In some embodiments, the reporting module may be configured to apply a metric, referred to herein as a ‘transparency metric’, to the extracted data that identifies instances of greenwashing. The reporting module may be further configured to route a communication indicating the identified instance of greenwashing to one or more client device. The above communication may form part of the above-described report that is constructed to detail analysis results of an entity's non-financial and ESG communications. By applying the transparency metric to identify instances of greenwashing, the reporting module may output a score or other measure of compliance with the transparency metric on a scale referred to herein as a ‘transparency index’.

Transparency index analysis conducted using the transparency metric may provide a positive output when input data reflect high environmental transparency or honesty in the communication channels of the entity concerned, i.e., when raw environmental data is consistent with data from other communication channels of the entity, and when salient environmental data is not omitted or is accurately interpreted in the other communication channels. By contrast, a negative output may be issued according to the transparency index when input data from the communication channels reflect low environmental transparency or honesty, i.e., when raw environmental data is inconsistent with data from other communication channels of the entity, and when salient environmental data is omitted or is mis-interpreted in the other communication channels.

### Further Embodiments of the Data Extraction Module

As explained above with reference to FIG. 1, a data extraction module (e.g., 110) extracts data from communication channels. Further embodiments of the data extraction module, its structure, and the methods by which it operates are now described.

Communication channels, such as those indicated above, may comprise media of one or more different format including, by way of example, text, images, tables, video, audio, PDFs, and HTML code. Furthermore, the structures used to encode those different forms of media may differ between communication channels. For example, two websites comprising the same substantive content may nonetheless have different structure at the source code level, as there may be a plurality of ways of encoding the same content using HTML, JavaScript, and CSS code.

The above-described data extraction module may be capable of simultaneously extracting data from a plurality of communication channels, with no requirement for data defining content from each communication channel to be encoded in a particular file format. The extraction module may further be configured to extract, from each communication channel, data of a plurality of formats; e.g., text and image data from a single communication channel.

There are many technical challenges involved in extracting data of varying formats from a plurality of sources whose content may be defined in data structures that are not structurally similar.

An initial challenge is loss of data during the extraction process. Since different files have different formats, some data is lost or modified due to mishandling of extraction process. According to the present techniques, the files may be extracted in their original format. This ensures that no data is lost due to conversion into other formats and the structure is maintained. A contributory challenge is dealing with the structure of files which possess different formats. To extract data from files, each file with distinctive formatting will have data structured differently to one another. The task of extracting the relevant data while mitigating the need for human intervention is one that must be accomplished.

The loss of structural information of how the text is laid out is apparent during the extraction process. In addition to previously discussed issues, the data that is collected is in a normalized format and is longer in the structured format, as seen on collection. A structured data approach will be used to mitigate loss of text structure.

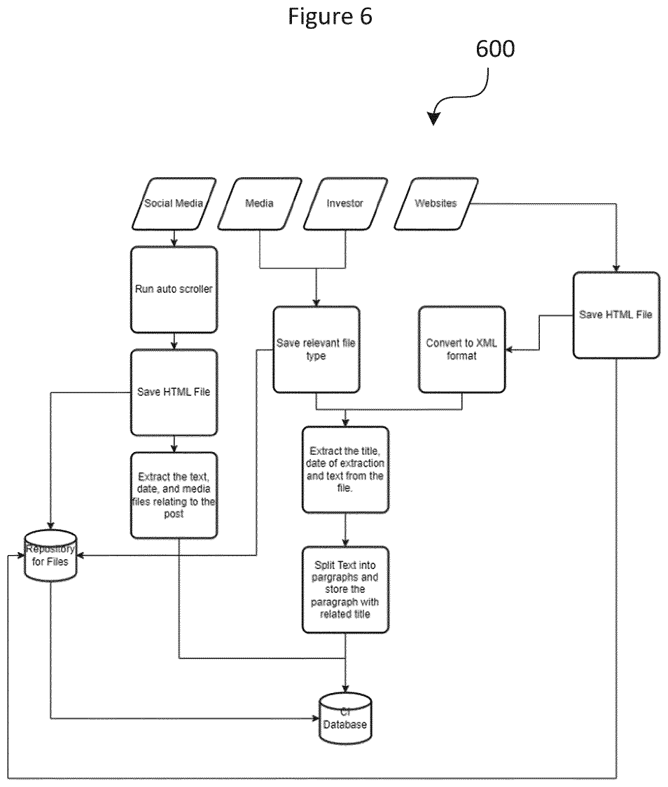

A first exemplary data extraction method is illustrated in FIG. 6, which shows a flowchart 600 comprising high-level steps for performing data extraction on a plurality of communication channels, which may each encode data of a plurality of media types and in data structures of different forms compared to each other.

A first branch of the flowchart 600 of FIG. 6 provides a high-level representation of the exemplary data extraction process being run on social media communication channels. The exemplary method comprises running an auto scroller, saving one or more HTML file associated with one or more corresponding social media post, extracting such data as: text, posting date, and media files in the post, and storing the extracted data in a database.

The step of saving one or more HTML files further comprises saving the raw HTML file in a repository.

A second branch of the flowchart 600 of FIG. 6 provides a high-level representation of the exemplary data extraction process being run on published media articles or investor communication channels. The second branch illustrates saving relevant files that represent the content of the communication channel. The files are saved to the repository so that the state of the webpage is recorded at the date of access. Titles, dates of extraction, and text from the file are extracted from the saved file. Text content is then split into segments and stored in the database in association with the title.

A third branch of the flowchart 600 of FIG. 6 provides a high-level representation of the exemplary data extraction process being run on a website. It will be noted that whilst the social media branch may be applied to social media websites, social media sites consist of a plurality of posts, which each are represented by uniform data structures. Therefore, a different data extraction method may be applied to the repeating uniform data structures of social media websites compared to other websites. The exemplary website branch of FIG. 6 comprises saving the HTML file and storing the HTML file in the repository. The HTML file is converted to an XML (Extensible Markup Language) format, a standard file format with which a skilled person would be familiar. Titles, dates of extraction, and text from the converted XML file are extracted. Text content is then split into segments and stored in the database in association with the title.

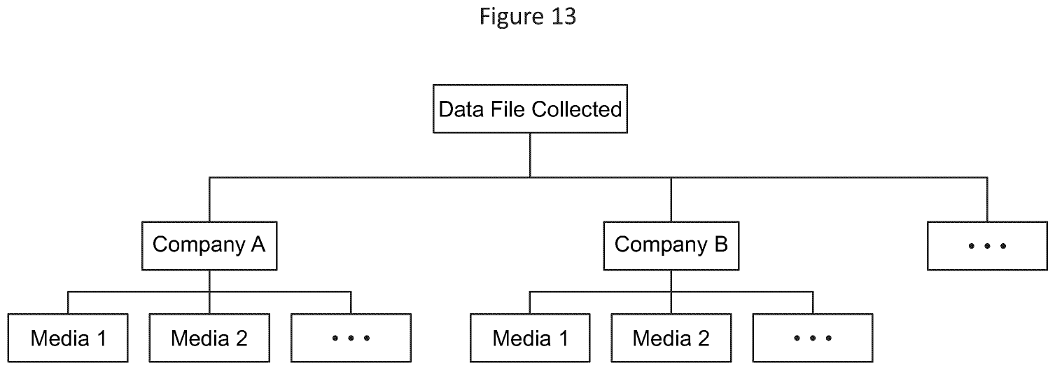

It will be further noted that the raw files stored in the repository are also saved in the CI (or alert) database with other extracted text content. Reference is made to FIG. 13, which shows a highly schematic diagram that represents an exemplary structure of the repository of FIG. 6. As seen in FIG. 13, data may be stored in a structured way, according to a company or other entity to which it relates. The repository may be used to record different versions of extracted files, e.g., changes to webpages.

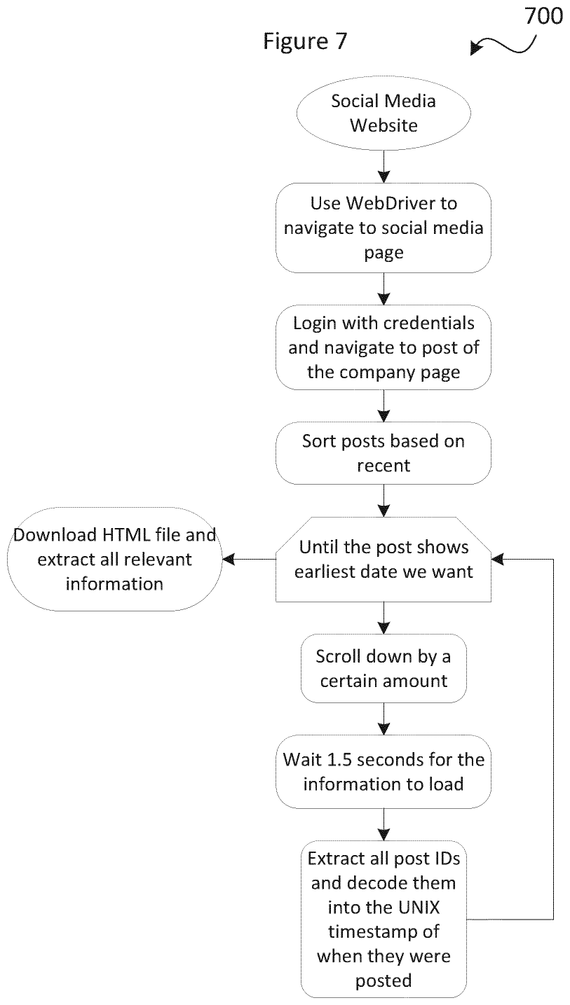

FIG. 7 shows a flow diagram 700 that represents exemplary steps carried out by the auto scroller described in the social media branch of flow 600 of FIG. 6. The flow 700 comprises accessing, the social media website, though the exemplary method of flow 700 may equally apply to other social media platforms. Google WebDriver, or any other suitable web navigation API, is used to navigate to a social media page associated with a target entity. Those skilled in the art will appreciate that tools such as Google WebDriver may enable automated introspection and control of an internet browser. The social media page and its content may be managed by, or on behalf of, the target entity.

It will be noted that the ‘target entity’ referred to above, may refer to a company or other organisation whose communication channels are subject to analysis by the presently described system.

Posts associated with the social media page of the target entity are sorted based on date such that most recent social media posts are processed first in a subsequent iterative data extraction process. In the iterative data extraction process, the web navigation tool controls the browser to scroll down by a predetermined amount at each iteration, such that at least some as yet unprocessed posts on the social media page can be processed. The exemplary method of flow 700 includes waiting for a predetermined amount of time, e.g., 1.5 seconds, to ensure that social media post data is loaded. The iterative process further includes extracting identifiers for each social media post and decoding the identifiers into the UNIX timestamp of when they were posted. Those skilled in the art will appreciate that the UNIX timestamp represents a time zone-independent measurement of time. The UNIX timestamp is a running total of seconds that have elapsed since a predefined ‘UNIX epoch’.

The iterative process of scrolling, waiting, and extracting post identifiers may be repeated until a post that was published earlier than a predefined time threshold is identified. That is, the tool may only scroll back through the social media page to identify posts that were posted after a predefined instant in time. The predefined time for identifying the earliest post may be defined as a UNIX timestamp, such that decoded UNIX timestamps of each post may be compared against the predefined threshold time to determine whether they should be extracted.

When the iterative process of identifying relevant posts is complete, or at the end of each iteration, an HTML file representing the identified social media posts is downloaded.

As described above, different communication channels may encode data in different structures and the types of data encoded in those different structures may also vary. It is with respect to the latter point that the exemplary method of FIG. 8 is directed.

FIG. 8 shows an exemplary flow diagram 800 that shows how data of different file types may be processed during data extraction. The flow 800 comprises four branches of the exemplary data extraction method. From left to right in FIG. 8, the four branches respectively relate to extraction and conversion of XBRL files, JSON files, PDF files, and XML files. It will be appreciated that, in accordance with FIG. 6, HTML files extracted from webpages may be converted to XML files and processed according to the fourth branch of flow 800.

The first branch relates to processing XBRL (Extensible Business Reporting Language) files. It would be understood by the skilled person that XBRL files are an XML-based documents used to encode business and financial data such as balance sheets and financial statements. According to the first branch of flow 800, an XBRL file is converted into a JSON file with correct headers. That is, the headers within the JSON file agree with those in the original XBRL file.

Those skilled in the art will appreciate that the JSON (Java Script Object Notation) format is an open standard data interchange format, commonly used for transmitting structured data.

The headers of the JSON file are iterated over, and headers relating to irrelevant information are filtered out in a data cleaning step, as is text content or values associated with the filtered- out headers.

Headers which are not filtered out are stored in a temporary data frame in association with corresponding text. The data is then ready for text-type splitting, which is described later herein.

The second branch of flow 800 relates to JSON files and shares its steps with the first XBRL branch. Input JSON files are processed by filtering out irrelevant headers and their associated data and storing the remaining non-filtered-out headers in association with their corresponding text in a temporary data frame.

The third branch of flow 800 is directed to extraction of data from PDF documents. A PDF document may comprise data of a plurality of types. The data extraction module may be configured to identify structures representing different media types in the PDF document.

Text in a PDF document may be directly extracted ready for subsequent processing. Extracted images and graphs may be extracted and transformed into text data. This may be done by applying a tool capable of identifying text within an image file; many suitable tools will be known to the skilled person. If text data is determined to comprise words related to ESG, the extracted text may be transformed into sentences ready for subsequent processing, the sentences reflecting the original context of the extracted text in the image or graph.

Data in a table structure within a PDF document may also be extracted and processed to identify ESG terms therein. This may be done through image processing, where the system may identify the relevant data using image classification. If the extracted textual data is determined to comprise words related to ESG, the extracted text may be transformed into sentences ready for subsequent text processing, the sentences also reflecting the original context of the table in the PDF document.

XML files, for example read from web pages, may be processed according to the fourth branch of the flow 800. The method comprises finding relevant divisions between portions of the XML file and storing text associated with each division in a temporary data frame in association with a title of the division.

It will be noted that the steps in the flow diagrams of FIGS. 6-8 may be conducted by the extraction module and processing module. For example, the extraction module may be responsible for downloading and extracting data from a communication channel, and the data processing module may be responsible for extracting data from the communication channels and for format conversion operations. The data processing module may be responsible for formatting the extracted data for storage and further processing by the analysis module.

FIG. 8a shows a flowchart that illustrates an exemplary method by which data may be extracted, and by which the original files stored in a CI repository. Whilst FIGS. 6 and 8 respectively show data extraction methods for different types of data channel and different extracted file type, FIG. 8a focuses on the steps for storing data in a CI database (also referred to as an alert database) and in the data repository (which may also be referred to as a CI repository). Each new extracted file is stored in the repository. For each new file, data is extracted and stored in the alert database (e.g., CI database in FIG. 6).

FIG. 8a also shows how extracted data may be used to generate the report or alert in the particular case where competitor data is used as comparison data. Data relating to competitors is extracted from the files and the extracted data is compared against comparison data. If there is any difference between the raw reporting data and the comparison data, the relevant data indicating this difference is stored in temporary storage. If, after processing the extracted data, the temporary storage is not empty, then it may be inferred that there is a difference between raw reported data and competitor data. In this case, a report and/or alert may be generated and routed to a relevant entity.

### Database Structures

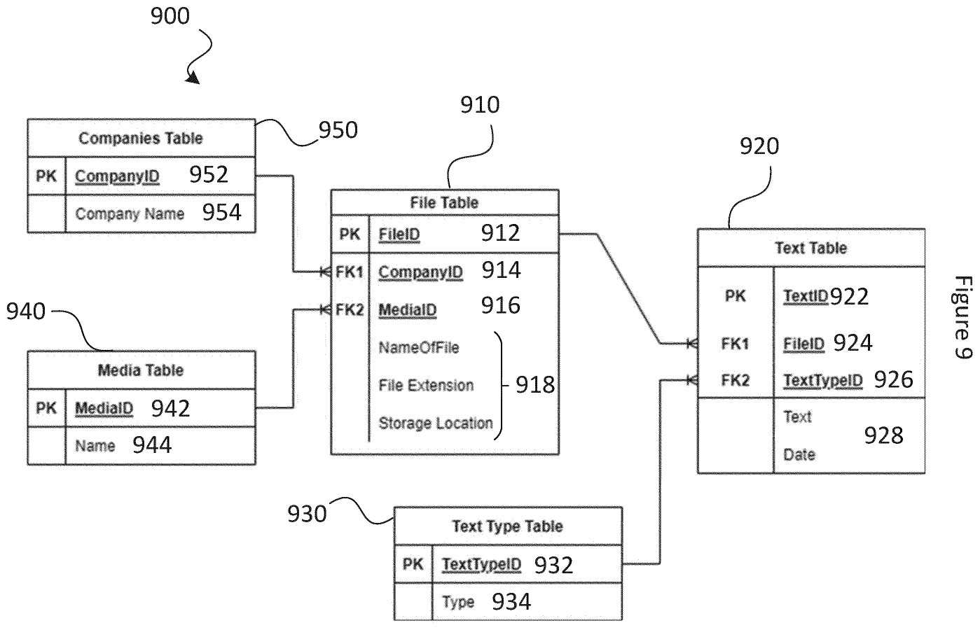

Reference is made to FIG. 9, which shows an exemplary relational database 900 in which segments of text data are stored in association with further data indicating respective source files from which each segment of text is extracted, a type of text (e.g., title, body text etc.), media data items within each source file, and data pertaining to a company or other entity in respect of which the source file was provided.

Source file data, text type data, media data, and companies data are respectively stored in a file table 910, a text type table 930, a media table 940, and a companies table 950. Tables 910-950 of the database may be interlinked within the database by reference. That is, identifiers associated with data items in a first table may indicate a storage location of associated data in a second table, as is described in more detail later.

The database 900 of FIG. 9 exemplifies the standardized data of common format, described earlier herein. That is, data from a plurality of communication channels, which may each encode data in different structures, and which may each comprise data of a plurality of formats, is extracted by the data extraction module and converted into a common format in a data structure, such as that of FIG. 9.

The text table 920 comprises an entry for each segment 928 of text data therein. Each segment 928 of text data may be associated with metadata, such as a date of extraction. The text table 920 further comprises, for each entry corresponding to a segment 928 of text data, a Text_ID data field 922, a File_ID data field 924 and a Text_Type_ID data field 926. These fields 922-926 may be populated with data values that respectively indicate an identifier for the associated segment of text, an identifier of a file from which the segment was extracted, and a text type that the segment represents.

The text type table 930 comprises an entry for each type of text type that text segment may be classified as. Each entry in the text type table 930 may be headed by a Text_Type_ID field 932, and header is associated with a text type 934. Particular entries in the text type table 930 may be referenced in the Text_Type_ID field 926 of a particular text segment 928 in the text table 920, thereby associating that particular text segment 928 with a text type 934 that corresponds to the referenced entry in the text type table 930.

The file table 910 comprises an entry for each source file that has been extracted. Each entry in the file table may comprise a File_ID header field 912. The File_ID field 912 may be populated with a unique identifier that specifies a particular source file. Each entry in the file table 910 may comprise file data 918 including a name, file type, and storage location of the associated file. Particular entries in the file table 910 may be referenced in the File_ID field 924 of a particular text segment 928 in the text table 920, thereby associating that particular text segment 928 with a file that corresponds to the referenced entry in the file table 910. Each entry in the file table 910 further comprises a Companies_ID data field 914 and a Media_ID data field 916, which may be populated to associate the entry in the file table 910 with an entry in the companies table 950 and the Media table 940 respectively, as described in more detail below.

The media table 940 comprises an entry for each media data item that has been extracted. Each entry in the media table 940 may comprise a Media_ID header field 942. The Media_ID field 942 may be populated with a unique identifier that specifies a particular media data item. Each entry in the Media table 940 may comprise metadata 944 such as a name of the associated media data item. Particular entries in the media table 940 may be referenced in the Media_ID field 916 of a particular entry in the file table 910, thereby indicating that the corresponding media data item was extracted from a source file represented by that particular entry in the file table 910.

The companies table 950 may associate a company or other entity with a unique Company_ID value stored in a Company_ID field 952 of the companies table 950. Each Company_ID value may be associated with metadata such as a company or entity name 954, also stored in the companies table 950. A Company_ID value associated with a company or entity may be referenced in the Company_ID field 914 associated with a particular entry in the file table 910, thereby indicating that the referenced company or other entity is associated with the source file represented by that particular entry in the file table 910.

It will be appreciated that the relation database 900 of FIG. 9 comprises functional, environmental data and other data extracted from other communication channels, all stored in a common format and interlinked for subsequent processing and analysis.

Types of functional data that may be extracted may include water consumption rates, water withdrawal data, scope 1 and 3 GHG emissions, land usage, and change in land usage. This list should be considered a non-limiting example. Other functional environmental data may be extracted from the communication channels.

### Artificial Intelligence and Machine Learning Pipelines

In some embodiments, artificial intelligence and machine learning techniques may be employed to carry out some processes and methods described herein. As indicated previously herein, Natural Language Processing (NLP) algorithms may be applied to automate processes within the analysis module 130.

In some embodiments, artificial intelligence may be used to automatically apply ESG themes to text segments that are extracted from source files of communication channels and processed into a common format, as described previously.

A machine learning model, for example trained on a bespoke training data set, may be used to analyse textual data of an input data set, the input data set being, for example, textual data comprised in the text table 920 of FIG. 9.

The input data set may be subject to one or more pre-processing step. The skilled person would understand that such standard pre-processing techniques as removing special characters, making all text lowercase, tokenizing text, removing punctuation and transforming the text into vectors, may be conducted as part of a pre-processing pipeline. The exemplary steps above are provided by way of example only.

The skilled person would further recognise that there is a plurality of candidate types of machine learning model from which to select. Examples may include support vector machines, XGBoost models, long short-term memory models, and convolutional neural networks.

When configuring a machine learning model for application in the context of the present invention, further considerations may be made such that the model is not overfitted on a training data set.

The description that follows relates to generation of training data sets and the training and application of a machine learning model in context of automating the classification of text segments by ESG theme. However, it will be appreciated that the same general techniques may be employed to establish a bespoke training data set and machine learning model configured to map KPI metrics to extracted text data of the communication channels.

Alternatively, a machine learning model for conducting KPI analysis may be configured by generating a ‘question and answer’ (Q&A) training set on which the model is trained. The training data may comprise a plurality of questions, a corresponding plurality of alleged answers to each of the plurality of questions, and a Boolean label indicating whether the alleged answer does or does not correctly answer the corresponding question. Each question may be included multiple times, so that there are multiple example sentences that are tagged ‘false’ and multiple example sentences that are tagged ‘true’, but in respect of the same question.

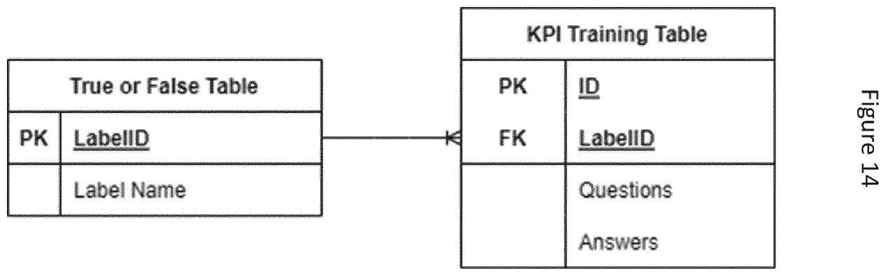

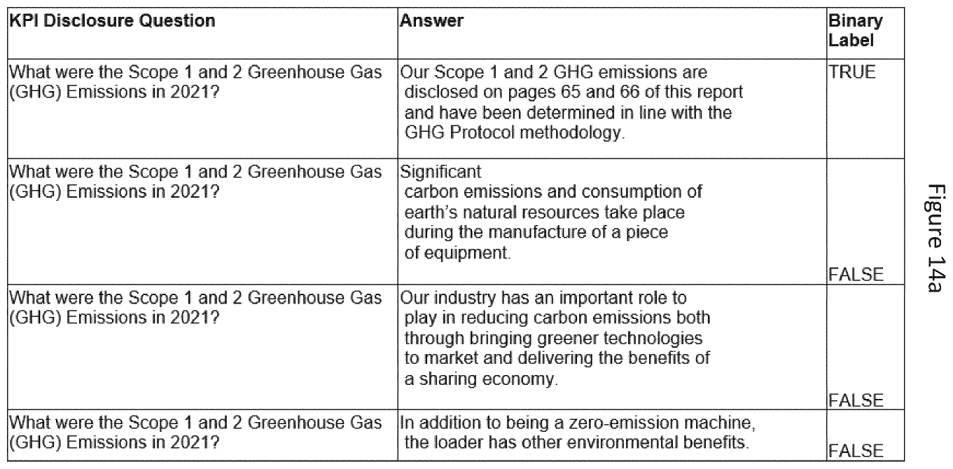

Reference is now made to FIGS. 14 and 14a. FIG. 14 shows a highly schematic diagram that illustrates a portion of a relational database that comprises KPI training data. As shown in FIG. 14, an entry in the KPI training table comprises a unique identifier (PK|ID) specifying a particular entry, a Label ID (FK|LabelID) specifying a particular type of assignable label, question data indicating a question, and answer data indicating an alleged answer to the question. The label ID provided for a particular entry may denote a predefined label in a true or false table, shown in the left-hand side of FIG. 14. A first predefined label and its corresponding label ID may represent “TRUE”, and a second predefined label may and its corresponding label ID may represent “FALSE”. In the KPI training table, a specified label ID for a particular entry defines whether the answer data represents a suitable response to the question in the question data. That is, the TRUE and FALSE labels may respectively indicate that the answer data does and does not answer the question in the question data.

FIG. 14a shows four exemplary entries in the KPI training table of FIG. 14. Each entry includes a question associated with an alleged answer to that question, and a binary label indicating whether the alleged answer truly answers the question.

A machine learning model for KPI analysis trained on the question data described above may operate by receiving a question as an input, and may be configured to identify, within one or more reference document comprising text data, a segment of text data within the reference document that answers the input question.

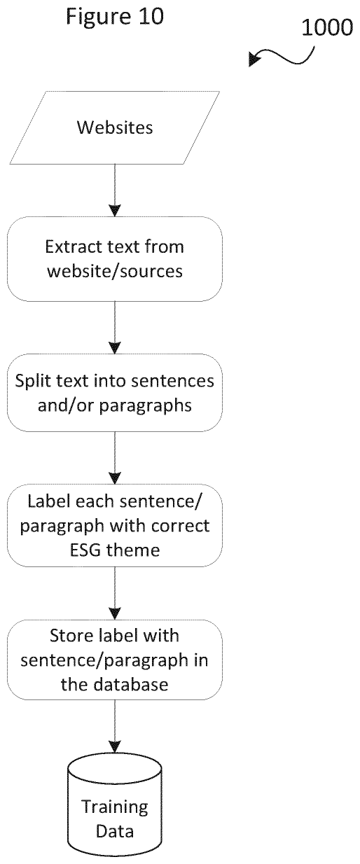

Returning to the machine learning techniques for automatic theme analysis, the machine learning model may be trained on a different set of training data. FIG. 10 shows a flowchart 1000 which illustrates an exemplary method by which training data may be collected and verified. The exemplary method of FIG. 10 comprises extracting text from one or more website or other source. Each source from which text data is extracted may be deliberately selected because it relates to a particular theme that the machine learning model is to be configured to identify. This may improve the efficiency with which the training data set may be constructed, as manual identification of particular text segments relating to particular ESG themes within a source file that relates to a large number of themes may require a greater level of analysis of the text compared to a source file that is focused on one or a small number of themes.

Text extracted from the sources may segmented, for example by paragraph or sentence.

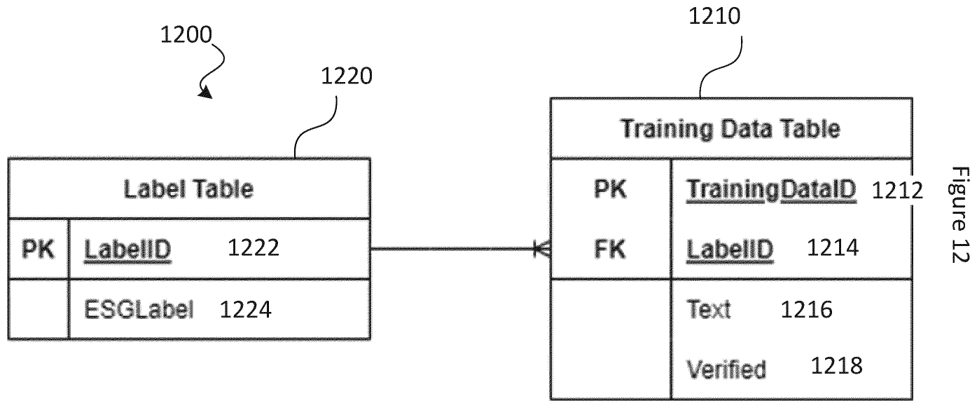

Each segment of text may be manually associated with a label, wherein the label may identify a correct ESG theme. The labels may be equivalent to the codes described previously herein, which are predefined and stored in the ESG database. Labels may be stored in association with the corresponding segment of text, as is described later with reference to the exemplary data structure of FIG. 12.

In the exemplary method of FIG. 10, labelled text data from a plurality of sources forms the set of training data on which the machine learning model is trained.

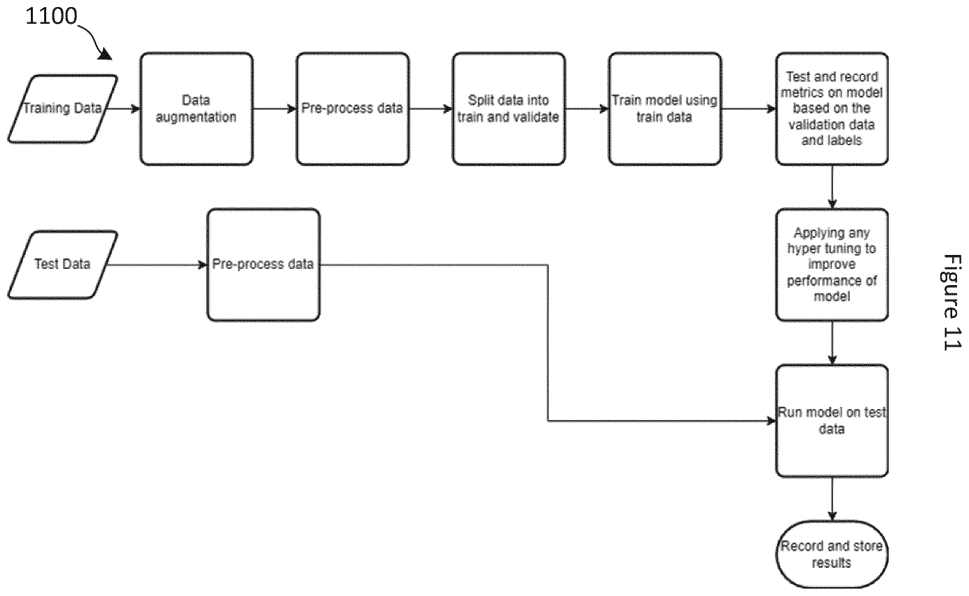

FIG. 11 shows a flowchart 1100 which illustrates an exemplary method by which training data may be used to train the machine learning model, and illustrates a high-level method of how test data, also referred to as input data, may be operated on by the model.

A first, upper branch of the flow 1100 of FIG. 11, illustrates how training data may be augmented using data augmentation techniques which will be known to the skilled person. According to the exemplary embodiment of FIG. 11, the augmented training data is pre-processed and then split into train data and validation data. The training data may be used to establish an initial fit of the machine learning model. The fitted model may operate on the validation data, to output predicted labels of the validation data. The model may be successively re-fitted and applied to the validation data to tune the model. Hypertuning using known techniques may also be conducted.

For the KPI data, a similar process will be used to determine whether a certain activity has been disclosed or not. The model will be trained in each of the different areas with text. After training, the model may be tested on a text and determine which area it is relevant to. The area and certainty score will be produced where that will help in determining how well they were able to disclose the KPI concerned. Different ranges help provide a simplistic view of results and provide exemplary texts from the different media sources to provide insight on improvements.

When the machine learning model is trained, the model may be applied to test data to automate the classification of text segments by theme, as seen in a second lower strand of the flow diagram 1100. Output results of the machine learning model are recorded and stored for further analysis. In practice, the machine learning model may assess a probability that a text segment should be associated with a particular label, for each of a plurality of candidate labels that may be applied. The machine learning output may, for each text segment, indicate a label for which it has determined a highest probability of relevance in respect of the text segment.

FIG. 12 shows an exemplary relational data structure 1200 configured to store textual training data in association with an ESG label. The structure 1200 comprises a training data table 1210 which may comprise an entry for each text segment. Each entry in the training data table 1210 may comprise a Training_Data_ID field 1212, which may be populated with a unique identifier corresponding to an associated text segment 1216, the text segment stored in the training data table 1210 in association with its corresponding unique identifier.

The exemplary data structure 1200 of FIG. 12 further comprises a label table 1220. The label table 1220 may comprise a plurality of entries, each representing an ESG label that is associable with a piece of text by the machine learning model, or other embodiment of the analysis module. Each entry in the label table 1220 may comprise a Label_ID header field 1222, which may be populated with a unique identifier that specifies a particular ESG label. Each entry may further comprise an ESG label field 1224, may be populated with the ESG label itself, for example indicating a human-readable indication of the associated label.

As explained previously, machine learning methods may also be employed when conducting the KPI analysis described herein. It will be appreciated that a relational data structure similar to that of FIG. 12 may be used to store training data text in association with a label, though the labels in the KPI analysis may differ to those in the ESG labelling application.

With reference again to the training data table 1210, each entry further comprises a Label_ID field 1214, which may be populated with a unique identifier indicating a particular label 1224. At the data structure level, ‘labelling’ of a text segment with a particular ESG label is done by populating the Label_ID field 1214 of a text segment in the training data table 1210 with a particular unique identifier of that particular ESG label 1224, which is specified in the label table 1220.

Entries in the training data table 1210 may further comprise a verification field 1218, which may be populated with a binary value indicating whether the label assigned to the text segment in that entry has been verified, e.g., by a human user.

1. A computer system for generating an environmental action trigger by monitoring raw environmental data of an organisation, the computer system comprising:
a data capture tool configured to capture raw environmental data from a first plurality of communication channels pertaining to an organisation, and to capture a set of comparison data from a second plurality of communication channels;
a data structure stored in computer memory and configured to store the captured raw environmental data and the set of comparison data;
a data analysis module configured to compare the captured raw environmental data against the set of comparison data; and
a reporting module configured to output, based on an analysis output of the data analysis module, an environmental action trigger, and to route an electronic communication comprising the environmental action trigger to one or more user interface of one or more respective computer device.

2. The system of claim 1, wherein the set of comparison data comprises a set of benchmark data, wherein the analysis module is configured to determine, based on the benchmark data, a threshold standard of environmental practice, and wherein the environmental action trigger comprises an alert, the alert indicating that the captured raw environmental data does not comply with the threshold standard of environmental practice.

3. The system of claim 1, wherein the set of comparison data comprises a set of external communication data issued by the organisation, wherein the data analysis module is configured to determine, based on the external communication data, a reported standard of environmental practice by the organisation, and wherein the output environmental action trigger is output based on a comparison of the reported standard of environmental practice and an actual standard of practice based on the raw environmental data.

4. The system of claim 3, wherein the electronic communication comprising the environmental action trigger further comprises a visual indication of a comparison index between the reported standard of environmental practice and the actual standard of practice based on the raw environmental data.

5. The system of claim 2, wherein the benchmark data comprises one or more of:
environmental regulatory data indicating a regulatory standard of environmental practice, and
competitor environmental data indicating an average reported standard of environmental practice of a plurality of competitor organisations.

6. The system of claim 3, wherein the external communications data comprises one or more of: social media publications, web pages, media articles, press releases, annual reports, sustainability reports, policy documents, ESG reports, ESG performance data sheets, spreadsheets, or other investor related communications.

7. The system of claim 3, wherein the analysis module is configured to automatically classify features of the captured data by environmental semantic theme.

8. The system of claim 7, wherein the analysis module comprises a machine learning model, the machine learning model trained on a training data set in which environmental semantic themes are labelled in text of a plurality of training documents.

9. The system of claim 8, wherein the machine learning model is one of: a support vector machine, an XGBoost model, a long short-term memory model, and convolutional neural network.

10. The system of claim 1, further comprising a data processing module configured to receive the captured data from the first plurality of communication channels in a first format and from the second plurality of communication channels in a second format and to process the captured data to convert the first and second format to a common format for storage in the database.

11. The system of claim 10, wherein the data structure is a relational database and each data entry in the relational database is stored in association with a unique identifier that specifies a respective source communication channel of the data entry.

12. The system of claim 1, wherein the one or more computer device, to which the electronic communication comprising the environmental action trigger is routed, comprises a computer device associated with the organisation.

13. The system of claim 1, wherein the one or more computer device, to which the electronic communication comprising the environmental action trigger is routed, comprises a computer device associated with a second organisation, the second organisation being an environmental regulatory organisation.

14. The system of claim 10, wherein the captured data from the first and second plurality of communication channels in the respective first and second formats is stored in the data structure in association with a timestamp that indicates a time at which the data is captured.

15. The system of claim 10, wherein the first and/or second format is in the group comprising: text data, HTML, PDF, image, JSON files, XML files, and data tables.

16. The system of claim 10, wherein the processing module is further configured to extract text content from the data captured from the first and second plurality of communication channels, and to define an entry in the relational database for each paragraph of text that is extracted.

17. The system of claim 9, wherein the processing module is further configured to extract text content from the data captured from the first and second plurality of communication channels, and to define an entry in the relational database for each paragraph of text that is extracted, and wherein the processing module is further configured to store, in association with each data entry associated with a paragraph of text, an indication of an environmental theme to which the paragraph is semantically directed.

18. A computer-implemented method for generating an environmental action trigger by monitoring raw environmental data of an organisation, the method comprising:
capturing, by a data capture tool, raw environmental data from a first plurality of communication channels pertaining to an organisation, and a set of comparison data from a second plurality of communication channels;
storing, in a data structure stored in a computer memory, the captured raw environmental data and the set of comparison data;
comparing, by a data analysis module, the captured raw environmental data against the set of comparison data; and
outputting, by a reporting module, based on an analysis output of the data analysis module, an environmental action trigger, and routing an electronic communication comprising the environmental action trigger to one or more user interface of one or more respective computer device.

19. A transitory or non-transitory computer readable media on which are stored computer-readable instructions which, when executed by a processor of a computer device cause the processor to:
capture, by a data capture tool, raw environmental data from a first plurality of communication channels pertaining to an organisation, and a set of comparison data from a second plurality of communication channels;
store, in a data structure stored in a computer memory, the captured raw environmental data and the set of comparison data;
compare, by a data analysis module, the captured raw environmental data against the set of comparison data; and
output, by a reporting module, based on an analysis output of the data analysis module, an environmental action trigger, and routing an electronic communication comprising the environmental action trigger to one or more user interface of one or more respective computer device.

20. (canceled)

21. (canceled)

22. (canceled)

23. (canceled)

24. The system of claim 3, wherein the comparison of the captured raw environmental data against the set of comparison data comprises determining that a first environmental factor is addressed in only one of the first and second plurality of communication channels.
